(19) United States
(12) Patent Application Publication
(10) Pub. No.: US 2024/0341476 A1
(43) Pub. Date: Oct. 17, 2024

(54) OUTDOOR SOLAR ELECTRIC RECLINER

(71) Applicant: Lamplight Farms Incorporated, Menomonee Falls, WI (US)

(72) Inventors: KYLE RESSLER, West Bend, WI (US); Ben Yu, New Berlin, WI (US)

(21) Appl. No.: 18/635,546

(22) Filed: Apr. 15, 2024

Related U.S. Application Data
(60) Provisional application No. 63/459,506, filed on Apr. 14, 2023.

(51) Int. Cl. A47C 1/024; A47C 1/14; A47C 7/62; A47C 7/68; A47C 7/72; H02S 20/30; H02S 30/20

(52) U.S. Cl. CPC A47C 1/0242; A47C 1/14; A47C 7/624; A47C 7/705; A47C 7/725; H02S 20/30; H02S 30/20

(57) ABSTRACT

An outdoor solar powered recliner of the invention has a seat main assembly having a seat surface and a back rest assembly. A leg rest is movable with respect to the seat main assembly. A solar panel on the seat main assembly provides power to a battery. The solar panel may be hidden beneath a mesh seat fabric or located adjacent seat back supports. An actuator manipulates the leg rest and/or back rest assembly. A control panel controls activation of at least one of a light source and the actuator and communicates with a circuit board and the battery. A cavity beneath the seat portion may be provided to house the battery, solar panel, and to store a solar equipped cover. Arms on the recliner may be provided with an accessory orifice to receive a mounting member of an accessory table.

### CROSS-REFERENCE TO RELATED CASES

This application claims the benefit of U.S. provisional patent application Ser. No. 63/459,506, filed on Apr. 14, 2023, and incorporates such provisional application by reference into this disclosure as if fully set out at this point.

### FIELD OF THE INVENTION

The present invention relates to outdoor furniture. More particularly, the invention relates to a solar powered recliner.

### BACKGROUND OF THE INVENTION

Outdoor furniture has traditionally been constructed for durability and weather resistance. As a result, most outdoor furniture is of a simple and rugged construction, lacking many comfort features that a user may be accustomed to and that are associated with indoor furniture, such as indoor recliners or other furniture.

### SUMMARY OF THE INVENTION

An outdoor solar powered recliner includes a seat main assembly having a seat surface and an under seat cavity. A back rest assembly is pivotally attached to the seat main assembly. The seat main assembly includes a leg rest that may be raised or lowered. In one embodiment a solar panel is located behind the back rest assembly. In another embodiment, a solar panel is installed in the under seat cavity and receives sunlight through a porous seat surface, e.g., through a mesh textile.

Actuators are preferably located in the under seat cavity for manipulating the back rest assembly and/or the foot rest. An LED may mounted within the cavity for providing downlighting.

A control panel is affixed to one of a right side base and a left side base. The control panel is preferably provided with a first switch, a second switch, a third switch, and an input for receiving an external charging cord. The switches are provided for manipulating the back rest assembly, the foot rest and the LED for various levels of underlighting.

In one embodiment, at least one arm rest member is provided with an accessory orifice for receiving a downwardly extending member of an accent accessory table for pivotally moving the accent accessory table.

A battery pack and circuit box board are preferably located within the cavity.

A wire harness is provided for connecting the solar panel, the control panel, the first actuator, the second actuator, the circuit board box, and the battery pack.

The seat main assembly may be comprised of treated wood, a composite material, or another suitable material. In one embodiment, at least one of the seat surface, the back supporting surface, and the leg supporting member are comprised of a porous material, such as a mesh textile.

In an embodiment wherein the seat surface is comprised of a porous material, a cavity mounted solar panel may be located beneath seat surface for receiving sunlight that passes through the porous material.

In one aspect of the invention, an accent table accessory is included that is a separate piece that is installed by the user. The accent table accessory is affixed to either armrest. Once installed, the accent table accessory can rotate freely.

In one aspect of the invention, the chair of the invention includes a solar panel for powering the recliner. The recliner chair of the invention may also be charged externally, e.g., by a USB-C port on an included controller.

In one aspect of the invention, a removable battery pack and circuit board box are mounted below the seat of the recliner. A panel on the back is secured with a latch that can flip open for battery access. A controller unit is mounted on the right side of the seat.

In one aspect of the invention, when the recliner is in the upright position, a user can sit down and stand up easily. Once seated, a user can easily recline and return to the upright position with the controls.

In one aspect of the invention, pressing the down arrow on the back rest controls will activate the back rest, lowering ¼ inch per press. A long press will continue to lower the back rest until it reaches the final position or until the button is released. Pressing the up arrow will activate the back rest, raising ¼ inch per press. A long press will continue to raise the back rest until it is fully upright or until the button is released. The back rest cannot be controlled at the same time as the leg rest.

### BRIEF DESCRIPTION OF THE DRAWINGS

FIG. 1A is a perspective view of an embodiment of the recliner of the invention comprised of treated wood;

FIG. 1B is a perspective view of an embodiment of the recliner of the invention comprised of composite;

FIG. 1C is a perspective view of an embodiment of the recliner of the invention wherein contacting surfaces are comprised of mesh textile;

FIG. 2 is an exploded view of the recliner of FIGS. 1A or 1B;

FIG. 3A is a perspective view of the recliner of FIGS. 1A or 1B showing an installation location for an accent table accessory;

FIG. 3B is a plan view of the recliner of FIG. 3A showing the accent table accessory installed and rotatable;

FIG. 4 is a rear perspective view showing an embodiment of the recliner of FIGS. 1A or 1B having a rear mounted solar panel;

FIG. 5 is an enlarged view of a control panel of the recliner of FIGS. 1A or 1B, wherein the control panel is shown receiving an external charge cord;

FIG. 6 is a rear perspective view showing a pivoting rear panel of a rear seat base panel being opened to allow access to a battery and circuit board box located within a cavity of the recliner;

FIG. 7 is a front perspective view of the recliner of FIG. 1A and 1B with an enlarged elevation view of the control panel;

FIG. 8A is a perspective view of the recliner of FIGS. 1A and 1B and a user shown sitting and standing;

FIG. 8B is a perspective view of the recliner of FIGS. 1A and 1B showing a user manipulating switches on the control panel for reclining and raising a seat back assembly and for raising and lowering a foot rest;

FIG. 9A is a perspective view of the recliner of FIGS. 1A and 1B, an enlarged view of an actuator and of the control panel, wherein manipulation of a third switch is used to recline a seat back assembly;

FIG. 9B is a perspective view of the recliner of FIGS. 1A and 1B, an enlarged view of an actuator and of the control panel, wherein manipulation of a third switch is used to raise a seat back assembly;

FIG. 10 is a collection of views of the recliner of FIGS. 1A and 1B;

FIG. 11 is a collection of view of the recliner of FIG. 1C showing an embodiment where a solar panel is located beneath a seating surface for receiving sunlight through the mesh textile;

FIG. 12 is a schematic showing the wiring harness that connects various components;

FIG. 13 shows a cover with solar panels and a cord for connecting to the battery of the recliner for charging the battery while the recliner is covered.

### DETAILED DESCRIPTION OF THE PREFERRED EMBODIMENTS

Referring now to the Figures, shown is outdoor solar powered recliner designated generally 10. Recliner 10 includes seat main assembly 20 (best seen in FIG. 2). Seat main assembly 20 has right seat base 22 having front surface, an upper surface, a rear surface, and rear protrusion 30. Seat main assembly 20 additionally includes left seat base 40 having a front surface, an upper surface, a rear surface, and a rear protrusion 48. Seat main assembly 20 further includes seat surface 50 that spans between right seat base 22 and left seat base 40.

Seat main assembly 20 further includes back rest assembly 60. Back rest assembly 60 is pivotally mounted to rear protrusion 30 of right seat base 22 and rear protrusion 48 of left seat base 40. Back rest assembly 60 has right seat back support 62 that extends upwardly from right seat base 22. Back rest assembly 60 further includes left seat back support 64 that extends upwardly from left seat base 40. Back rest assembly additionally includes back supporting surface 66 that extends between right seat back support 62 and left seat back support 64.

Right seat main assembly 20 additionally includes leg rest 70. Leg rest 70 is movable with respect to seat main assembly 20. In one embodiment, leg rest 70 is pivotally mounted adjacent the front surface and the upper surface of right seat base 22, and pivotally mounted adjacent the front surface and the upper surface 44 of left seat base 40. Leg rest 70 defines leg supporting member 72 (FIGS. 10, 11) defining rear surface 74 (FIG. 2).

Seat main assembly 20 has rear seat base panel 80 (FIGS. 2, 6). Rear seat base panel 80 has a fixed rear panel 82 and a pivoting rear panel 84. Seat main assembly 20 defines cavity 90 that is defined by right seat base 22, left seat base 40, leg rest 70, and rear seat base panel 80. In a preferred embodiment, pivoting rear panel 84 is secured to fixed rear panel 82 with latch 92. Pivoting rear panel 84 allows access to cavity 90.

In one embodiment, right solar panel support 100 is affixed to right seat back support 62. Left solar panel support 102 is affixed to left seat back support 64. Panel 104 is located between right solar panel support 100 and left solar panel support 102.

First actuator 110 is affixed to rear surface 74 of leg supporting member 72 of leg rest 70. First actuator 110 is located within cavity 90 period. Second actuator 116 is provided for manipulating back rest assembly 60. Second actuator 116 is located within cavity 90.

LED 120 (FIG. 2) is mounted within cavity 90 for providing downlighting.

Control panel 130 is affixed to one of right side base 22 and left side base 40. Control panel 130 is preferably provided with first switch 132, second switch 134, third switch 136, and input 138 for receiving an external charging cord.

In one embodiment, when first switch 132 activates LED 120. In one embodiment, upward presses of first switch 132 increases the brightness of LED 120. In one embodiment, a downward press of first switch 132 decreases brightness of LED 120, including deactivation of LED 120. Preferably, LED 120 is adapted to illuminate at multiple levels of brightness. For example, five levels of brightness, i.e. low, low/medium, medium, medium/high, and high.

In one embodiment, second switch 132 functions to raise or lower leg rest 70 by activating one of first actuator 110 and second actuator 116. In one embodiment, each upward press of second switch 134 raises leg rest 70 by a fixed increment. In one embodiment, the fixed increment is ¼ inch. In one embodiment, each downward press of second switch 134 lowers leg rest 70 by a fixed increment. In one embodiment, the fixed increment is ¼ inch. In one embodiment, a long downward press of second switch 134 lowers leg rests 70 until leg rest 70 is fully closed or until second switch 134 is released.

In one embodiment, third switch 136 functions to raise or lower back rest assembly 60. In one embodiment, each downward press of the third switch 136 lowers back rest assembly 160 by a fixed increment. In one embodiment, the fixed increment is ¼ inch. In one embodiment, a long downward press of the third switch 136 will continue to lower back rest assembly 60 until backrest assembly 60 reaches a final position or until third switch 136 is released. In one embodiment, each upward press of third switch 136 raises back rest assembly 60 by a fixed increment. In one embodiment, the fixed increment is ¼ inch. In one embodiment, a long upward press of the third switch, 136 raises backrest assembly 60 until back rest assembly 60 is fully upright or until third switch 136 is released.

Referring primarily to FIG. 2, right arm rest assembly 140 is affixed to right seat base 22. Right arm rest assembly 140 includes right arm rest member 142 having and underside. Right arm rest member 142 defines right access orifice 146. Right arm rest assembly 140 include right rear leg 148 that connects to the underside of right arm rest member 142. Right arm rest assembly further includes right front leg 150 that extends forwardly from right rear leg 148.

Still referring primarily to FIG. 2, left arm rest assembly 160 is affixed to left seat base 40. Left arm rest assembly 160 defines left arm rest member 162 having an underside. Left arm rest member 162 further defines left access orifice 166. Left arm rest assembly 160 includes left rear leg 168 that connects to the underside of left arm rest member 162. Left front leg 170 extends forwardly from left rear leg 168.

Rear cross support 180 is provided for connecting right rear leg 148 and left rear leg 168.

Accent table accessory 190 may be provided. Accent table accessory 190 defines table piece 192 and downwardly extending member 194. Downwardly extending member 194 is for being received in one of right accessory orifice 146 and left accessory orifice 166 for pivotally mounting accent table accessory 190 to a selected one of right arm rest member 142 and left arm rest member 162.

Battery pack 200 is located within cavity 90. In one embodiment, battery pack 200 is a lithium ion battery pack.

Circuit board box 210 (FIG. 6) is also preferably located within cavity 90. Wire harness 220 (FIG. 12) is provided for connecting solar panel 104, control panel 130, first actuator 110, second actuator 116, circuit board box 210, and battery pack 200. A weather cover, e.g., cover 240 (FIG. 6) may be provided and foldable to be received within cavity 90. In one embodiment, cover 240 is shaped to fit on recliner 10 and possess cover solar panels 242 that may be connected, e.g., via cord 244 to input 138 or another input for charging battery 200 while recliner 10 is covered.

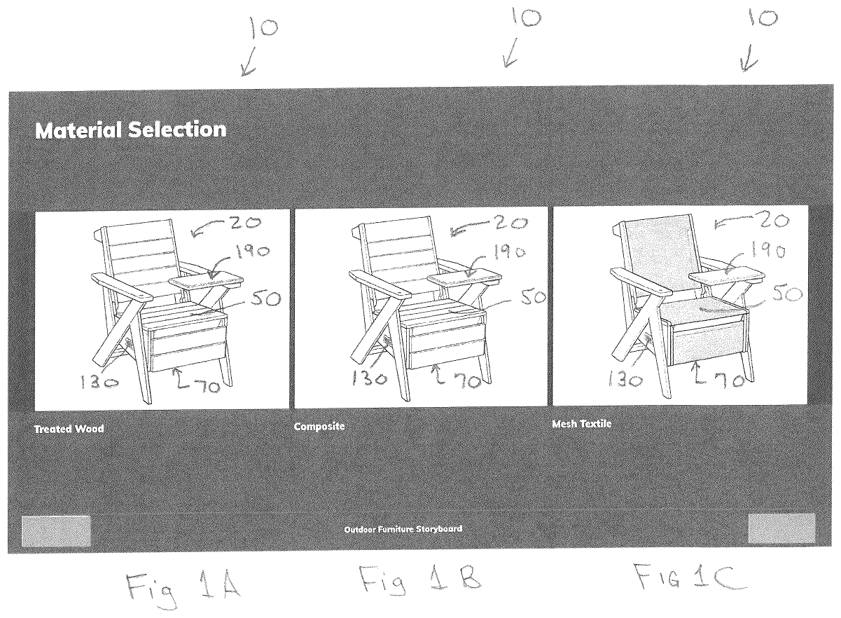

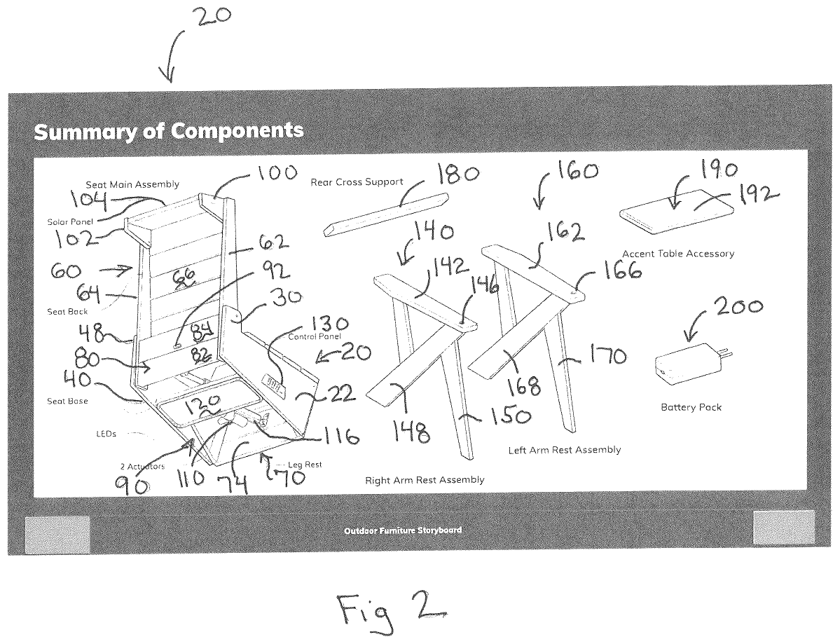

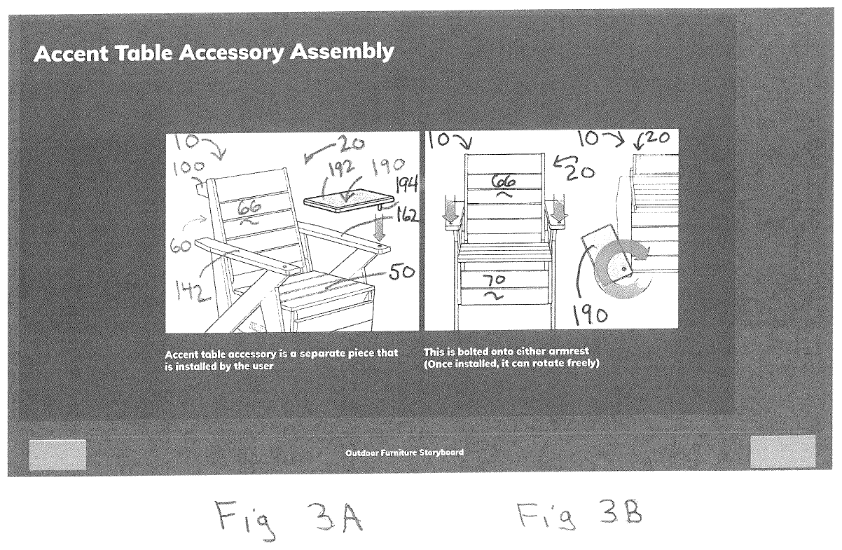

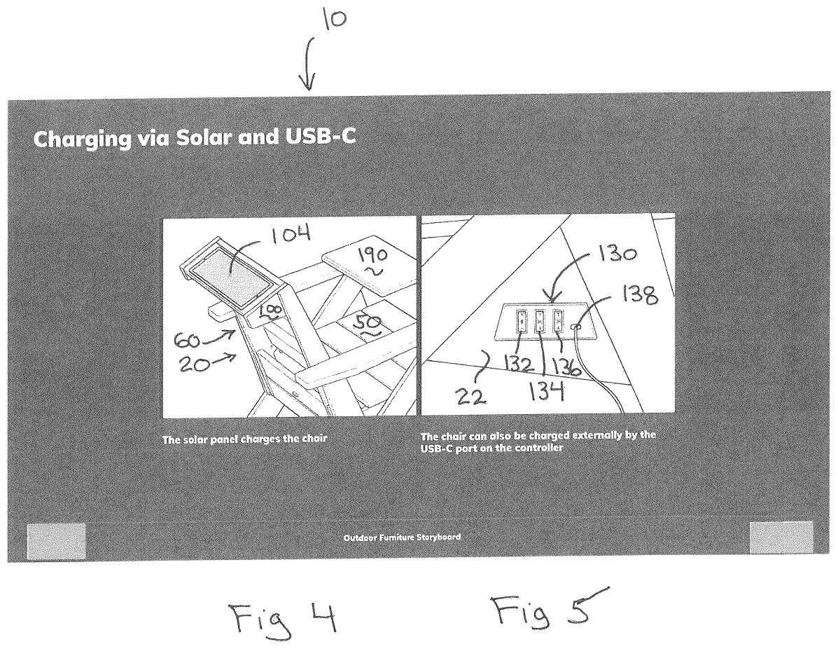

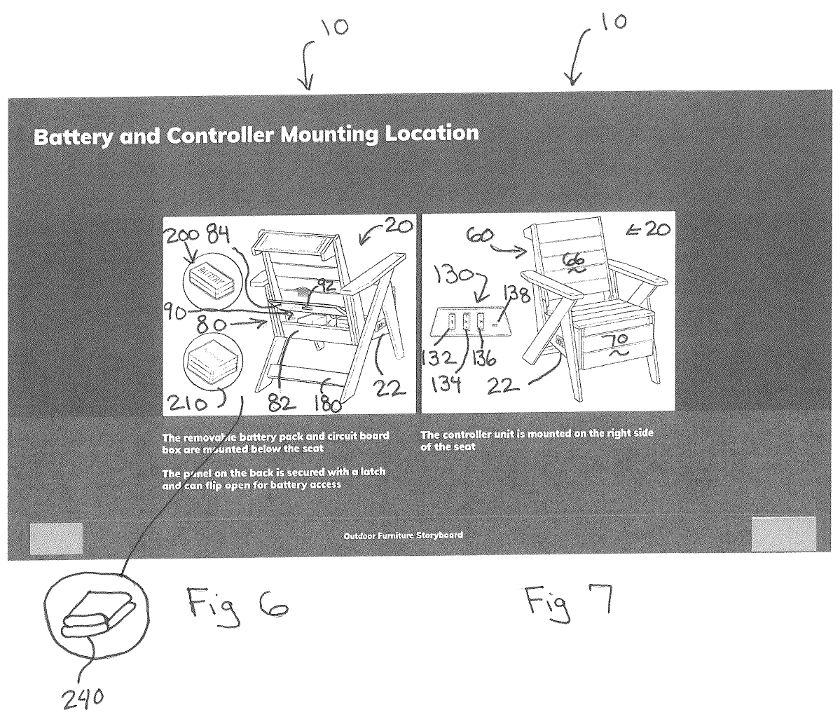

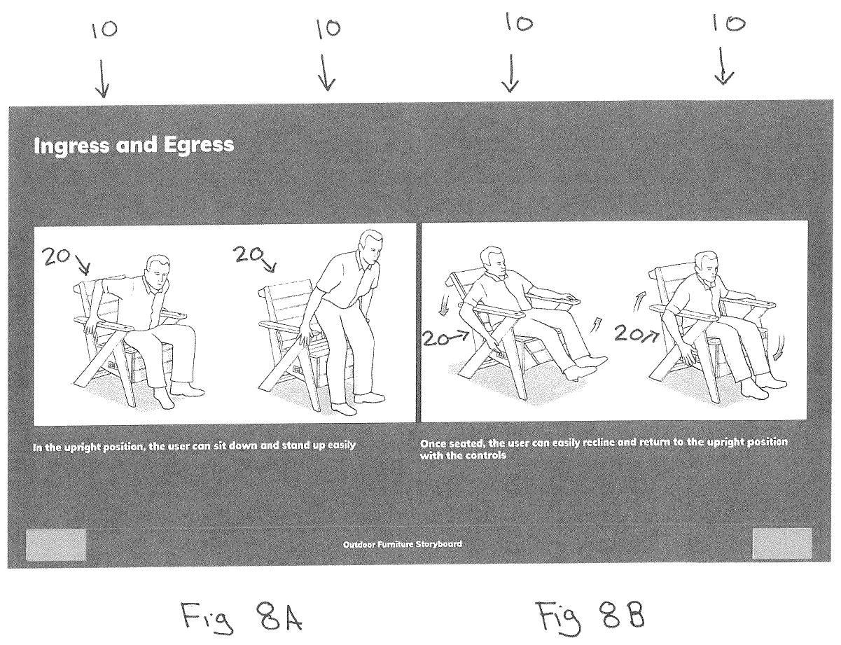

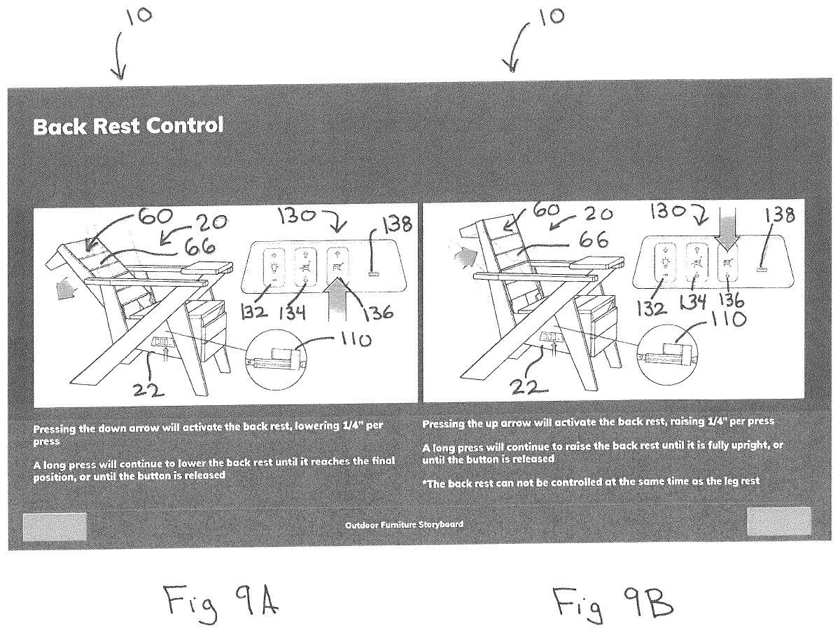

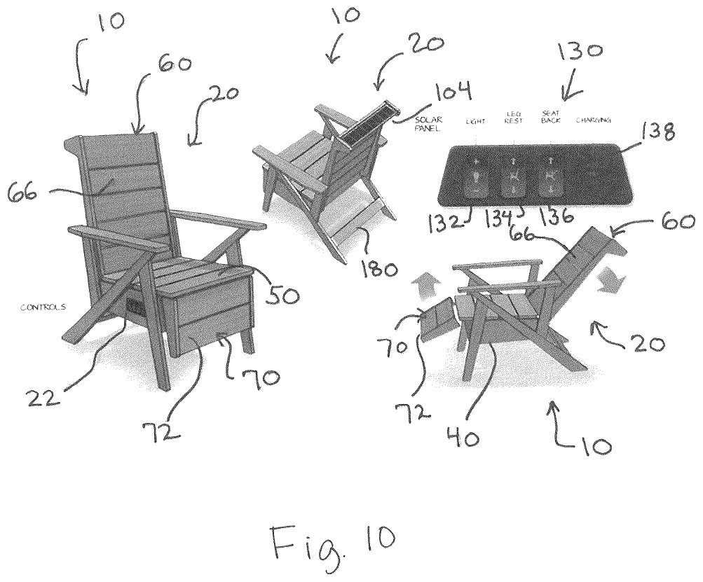

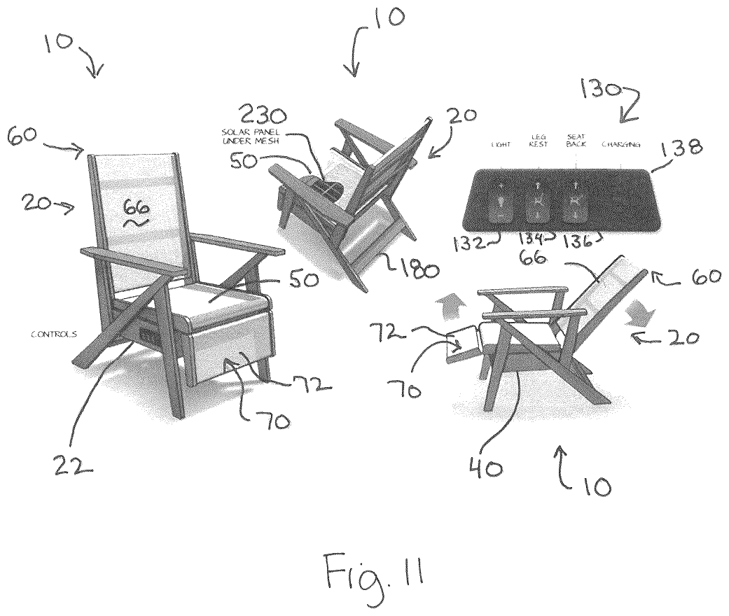

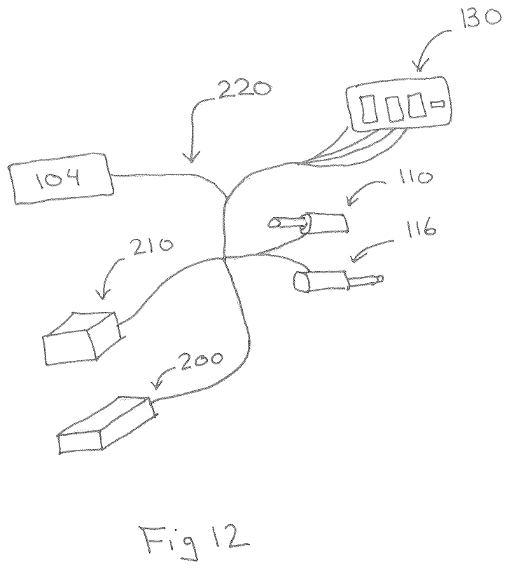

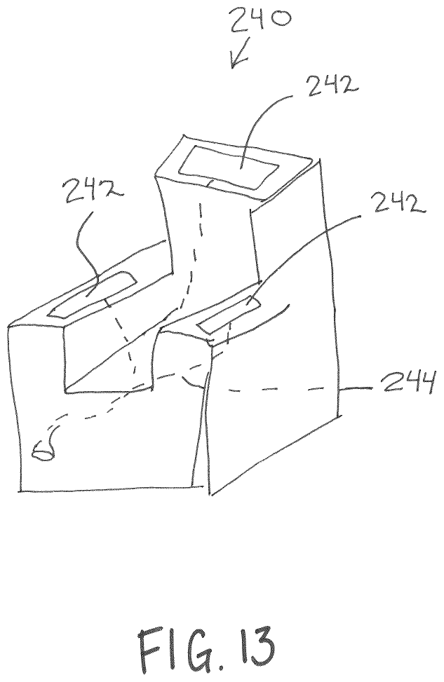

In one embodiment, components of seat main assembly 20 are comprised of treated wood (FIG. 1A). In another embodiment, components of seat main assembly 20 are comprised of a composite material (FIG. 1B). In one embodiment, at least one of seat surface 50, back supporting surface 66, and leg supporting member 72 are comprised of a mesh textile (FIG. 1C, 11).

Referring to FIG. 11, in an embodiment wherein seat surface 50 is comprised of a mesh textile, a cavity mounted solar panel 230 may be located beneath seat surface 50 for receiving sunlight that passes through a porous embodiment of seat surface 50, such as mesh textile or other porous material.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%.

When, in this document, a range is given as “(a first number) to (a second number)” or “(a first number)-(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. An outdoor solar powered recliner comprising:
a seat main assembly having a seat surface and a back rest assembly;
a leg rest below said seat surface, said leg rest movable with respect to said seat main assembly;
a solar panel on said seat main assembly;
an actuator for manipulating said leg rest;
a control panel on said seat main assembly for controlling activation of at least one of a light source and said actuator;
a circuit board for controlling said actuator;
a battery in communication with at least one of said solar panel, said control panel, said actuator, and said circuit board.

2. The recliner according to claim 1 wherein said seat main assembly comprises:
a right seat base having a front surface, an upper surface, a rear surface, and a rear protrusion;
a left seat base having a front surface, an upper surface, a rear surface, and a rear protrusion;
said seat surface spanning between said right seat base and said left seat base;
said back rest assembly pivotally mounted to said rear protrusion of said right seat base and said rear protrusion of said left seat base.

3. The recliner according to claim 2 wherein said back rest assembly comprising:
a right seat back support extending upwardly from said right seat base;
a left seat back support extending upwardly from said left seat base; and
a back supporting surface extending between said left seat back support and said right seat back support.

4. The recliner according to claim 2 wherein:
said leg rest is pivotally mounted adjacent to said front surface and said upper surface of said right seat base and adjacent to said front surface and said upper surface of said left seat base.

5. The recliner according to claim 2 wherein said seat main assembly further comprises:
a rear panel, wherein said seat main assembly includes a cavity defined by said right seat base, said left seat base, said leg rest, a back supporting surface of said back rest assembly, said rear panel providing selective access to said cavity.

6. The recliner according to claim 5 wherein:
said circuit board is located in said cavity.

7. The recliner according to claim 3 wherein:
said solar panel is proximate to at least one of said left seat back support and said right seat back support.

8. The recliner according to claim 1 wherein:
said solar panel is located beneath said seat surface.

9. The recliner according to claim 1 wherein:
said actuator is one of a first actuator and a second actuator affixed to a rear surface of said leg rest.

10. The recliner according to claim 5 wherein:
said actuator affixed is located within said cavity.

11. The recliner according to claim 5 further comprising:
a light source in said cavity for providing illumination.

12. The recliner according to claim 1 wherein:
said control panel is affixed to one of a right seat base and a left seat base.

13. The recliner according to claim 1 wherein:
said control panel having at least one switch, and an input for receiving an external charging cord.

14. The recliner according to claim 13 wherein:
one of said at least one switch activates said light source and controls a brightness of said light source.

15. The recliner according to claim 13 wherein:
one of said at least one switch activates said actuator for raising or lowering said leg rest.

16. The recliner according to claim 13 wherein:
one of said at least one switch activates said actuator for raising or lowering said back rest assembly.

17. The recliner according to claim 2 further comprising:
a right arm rest assembly affixed to said right seat base, said right arm rest assembly defining an right arm rest member having an underside and defining a right accessory orifice, said right arm rest assembly having a right rear leg connecting to an underside of said right arm rest member, a right front leg extending forwardly from said right rear leg;
a left arm rest assembly affixed to said left seat base, said left arm rest assembly defining a left arm rest member having an underside and defining a left access orifice, said left arm rest assembly having a left rear leg connecting to an underside of said left arm rest member, a left front leg extending forwardly from said left rear leg.

18. The recliner according to claim 17 further comprising:
an accent table accessory defining a table piece and a downwardly extending member, said downwardly extending member for being received in at least one of said right accessory orifice and said left accessory orifice for pivotally affixing said accent table accessory to one of said right arm rest member and said left arm rest member.

19. The recliner according to claim 1 wherein:
said battery is located in a cavity within said seat main assembly.

20. The recliner according to claim 1 wherein:
said battery is a Li-Ion battery pack.

21. The recliner according to claim 1 further comprising:
a wire harness for connecting said solar panel, said control panel, said actuator, said circuit board, and said battery.

22. The recliner according to claim 1 wherein:
said seat main assembly is comprised of treated wood or composite.

23. The recliner according to claim 1 further comprising:
an input on said seat main assembly, said input in communication with said battery.

24. The recliner according to claim 23 wherein:
said seat main assembly defines at least a portion of a cavity; and further comprising:
a cover foldable for storage in said cavity, said cover having a cover solar panel affixed thereto, said cover solar panel in communication with a charging cord for insertion in said input for charging said battery.

25. The recliner according to claim 1 wherein:
wherein at least one of said seat surface, a back supporting surface of said back rest assembly, and a leg supporting surface of said leg rest are comprised of mesh textile.
